(19) United States
(12) Patent Application Publication
(10) Pub. No.: US 2009/0276720 A1
(43) Pub. Date: Nov. 5, 2009

(54) Methods and systems for the distance-based sharing of information

(76) Inventor: Vivek A. Hutheesing, Berkeley, CA (US)

Correspondence Address: PERKINS COIE LLP, P.O. BOX 1208, SEATTLE, WA, 98111-1208, US

(21) Appl. No.: 12/383,111

(22) Filed: Mar. 18, 2009

Related U.S. Application Data
(60) Provisional application No. 61/037,682, filed on Mar. 18, 2008.

(51) Int. Cl. G06F 15/16; G06F 3/048; G06F 17/30

(52) U.S. Cl. 715/764; 709/217; 709/206; 707/104.1; 707/E17.009

(57) ABSTRACT

Disclosed is a method for distance-based sharing of content. The method comprises, in one embodiment, receiving a request to send content to one or more of a plurality of registered users based on a distance from a first geographical location. The method also comprises determining recipients of the content based on the distance and based on location identification data associated with the registered users. The method further comprises making said content available to said recipients. In various embodiments, the method also includes publishing the content on a website accessible to the recipients and sending said content to the recipients via email. The first geographical location may be a location of a user requesting to send the content to the recipients. The content may be filtered based on a geographic filter, a people-based filter, an interest-based filter, or any other filter.

### CROSS-REFERENCE TO RELATED APPLICATIONS

This application claims priority to and is a utility conversion of Hutheesing's provisional application No. 61/037,682 filed Mar. 18, 2008, the contents of which are incorporated herein by reference. This application also references Hutheesing's utility application no. 11/972,608 filed Jan. 10, 2008, the contents of which are incorporated herein by reference.

### BACKGROUND

The adoption and usage of email has grown very rapidly over the last decade due to a number of factors. Email clients that provide the environments within which users receive, store, compose and send emails have become more user-friendly and more useful. Email addresses, which are assigned to individual users, have become an increasingly valuable form of online identification as the universe of websites and applications that require them has rapidly expanded.

Evidence of the rapid growth in both the number of users and the number of emails sent per user comes in various forms. One of these is that many users now have multiple email addresses, affording them the flexibility of deciding which online identity they wish to disclose to a particular website, or how to “macro-categorize” their communications with another user of email as work-related, personal, university-related or some other category. The email client—Outlook, Gmail, AOL, etc.—then allows senders and recipients of email to further “micro-categorize” the growing volume of emails by employing folder hierarchies within the email client. The powerful integration of search within the Gmail client is yet another way of helping users to find what they are looking for amidst the growing volumes of emails that have already been sent and received. Advances in archiving and retrieval techniques are another form of evidence. Finally, perhaps the most interesting evidence of the growth in the use of email is the content of the emails themselves. Increasingly, emails are becoming quick-shot messaging agents with very little content in the body of the email, as opposed to long-form compositions. Again, this is a natural consequence of their increasing volume.

One un-intended consequence of the rapid growth in the use of email is that senders often send emails to recipients who do not wish to receive them. The growth of spam has been almost as significant as the growth of email use, and has led to an anti-spam industry of sizeable proportions. There are several obvious reasons for this consequence. First, just because one individual sends an email to another individual in order to communicate with them does not necessarily mean that the sender wishes to have a response from the recipient. Yet once the sender's email has been sent, their email address no longer remains in their control. Second, the ability to broadcast a single email to multiple recipients, or to “cc” them as the case may be, serves only to expand the number of ways that unintended recipients can gain access to email addresses that the owners of those email addresses would have preferred not to divulge. Third, email addresses provide a way to identify ourselves to third parties in order to accomplish something, but such third parties have no accountability that limits how or with whom they use our email address in future.

Broadly speaking, there two very common approaches in use today that reduce the number of unwanted emails received by recipients. The first is “spam filtering” which directly combats the existing problem faced by recipients who do not want to receive emails from senders who have their email addresses. The second is “intermediation” which prevents the existing problem from getting worse by putting an intermediary—say a website for example—between senders and recipients. This requires senders and recipients to share their email addresses with the intermediary but not each other. This way, recipients, not senders, determine whether and how frequently they receive emails. This is how most web-based collaboration platforms work today, as it is more acceptable for most to trust the platform with one's email address, if not everyone who joins it. In this context, recipients typically receive short notifications in their email inboxes rather than full text compositions. These notifications enable recipients to log into the intermediary to read what the sender has written.

While the widespread use of spam filtering and intermediation has increased the relevance of what recipients actually receive and read, the impact of these approaches has been limited as they do little to address the supply side of the spam problem. Email, the killer application, offers senders an undeniable edge (over recipients) by enabling them to reach anyone, anywhere, at anytime, so long as they have recipients' email addresses.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts a flowchart 100 of a method for “sending out” Dmails based on the geographical proximity of prospective recipients (to the sender).

FIG. 2 depicts a flowchart 200 of a method for “receiving” Dmails based on the geographical proximity of prospective senders (to the recipient).

FIG. 3 depicts a flowchart 300 of a method for “filtering” Dmails based on the geographical proximity of prospective senders (to the recipient), as well as other criteria (e.g. the identity of senders, the role of senders, the subject chosen by senders, etc.)

FIG. 4 depicts a flowchart 400 of a method for “replying” to an in-progress Dmail interaction with the other individual who is participating in the interaction.

FIG. 5 depicts a flowchart 500 of a method for “targeting in” Dmails based on the geographical proximity of prospective recipients (to the sender's interest).

FIG. 6 depicts illustrations of screen sequences for “sending out” a Dmail

FIG. 7 depicts illustrations of screen sequences for “receiving” a Dmail

FIG. 8 depicts illustration of screen sequences for “filtering” a Dmail

FIG. 9 depicts illustrations of screen sequences for “replying” to a Dmail

FIG. 10 depicts illustrations of screen sequences for “targeting in” a Dmail

FIG. 11 depicts an example of a system for distance based content distribution

FIG. 12 depicts an example of a method for providing incentives for users to join the distribution platform

FIG. 13 depicts an example of a system for a distance-based content distribution system

### DETAILED DESCRIPTION

In the following description, several specific details are presented to provide a thorough understanding of the embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments of the invention.

The methods and systems described herein may operate in a distribution platform such as the one described in the utility patent application no. 11/972,608, filed Jan. 10, 2008, which is hereby incorporated by reference.

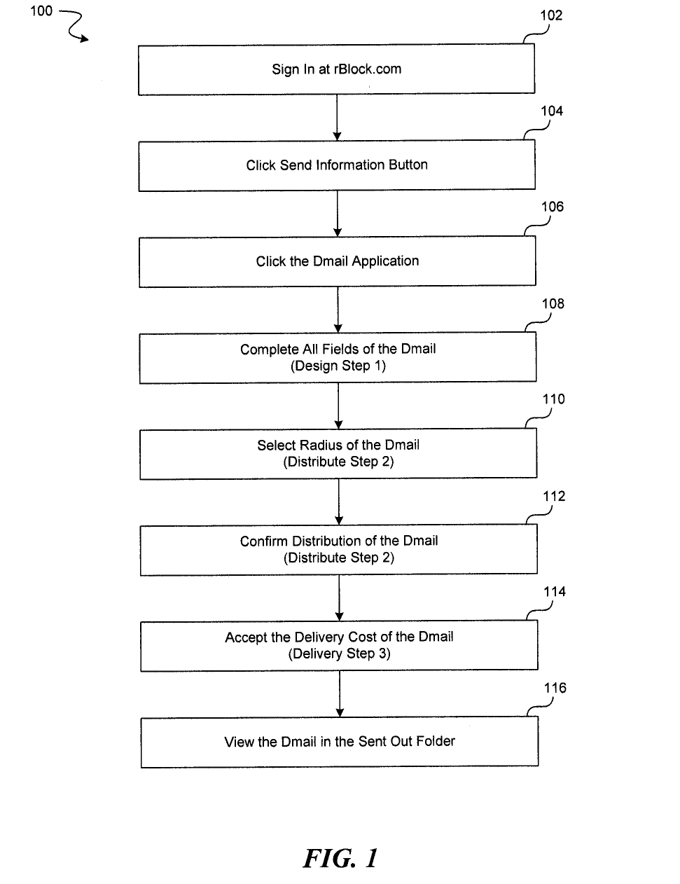

FIG. 1 depicts a flowchart 100 of a method for the distance based sharing of information. The method is enabled by the methods and systems described earlier in the regular application Ser. No. 11/972,608 filed Jan. 10, 2008. The method enables the sender of a Dmail, or distance-based email, to go through similar steps as those involved in sending an email. However, instead of choosing the recipients of their email, the sender chooses a region within which the Dmail will be distributed. Each user of the distribution platform may be assigned a location identification, which corresponds to a geographic location of the user, such as his/her residence or a business address. A user may have more than one location identification assigned to him/her. In a non-limiting example, the location identification may be assigned upon registration of the user on the distribution platform and may be modified later. In on embodiment, the region may be expressed in terms of distance from a user defined geographic location, in terms of postal codes, or in terms of blocks—for example, up to 3 blocks from the distribution platform—because residents on the distribution platform are correlated to their block.

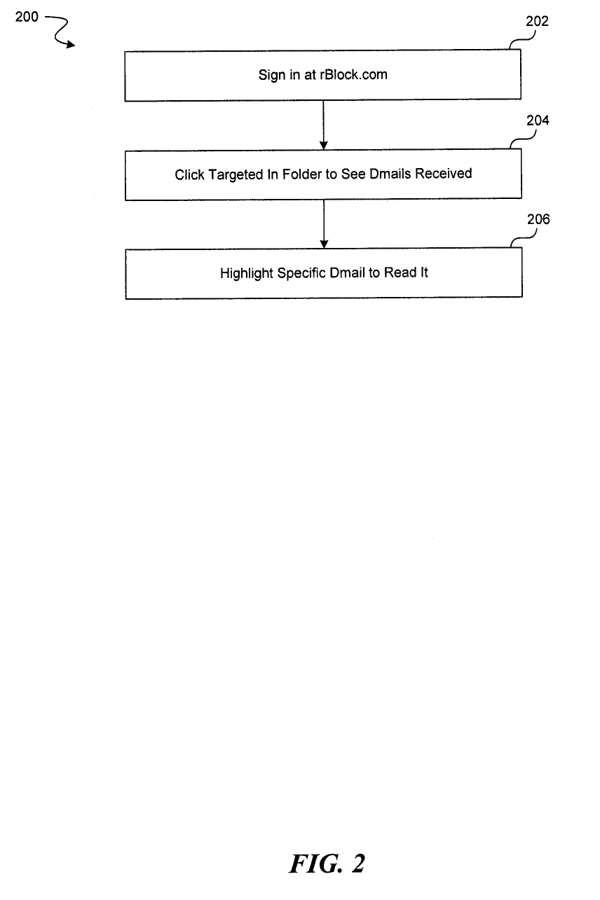

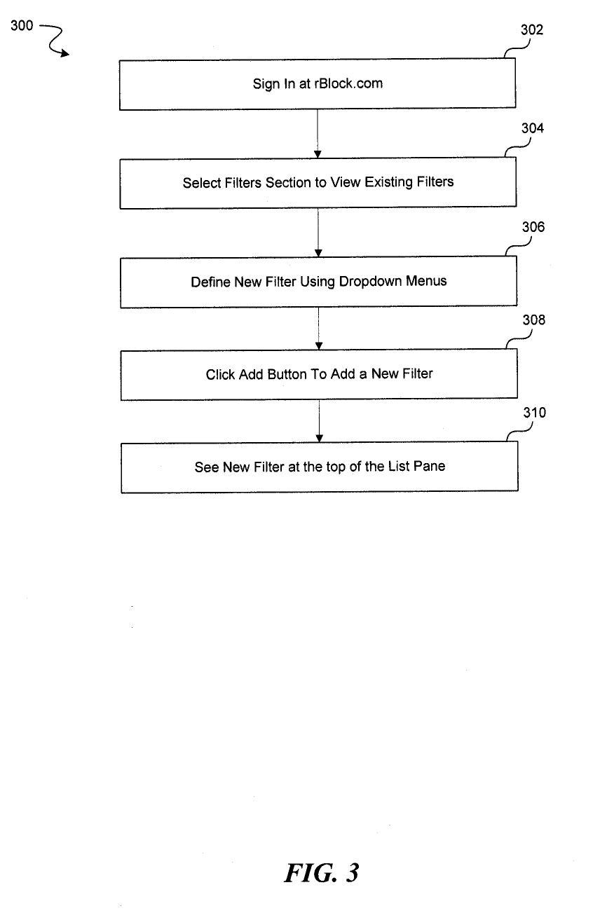

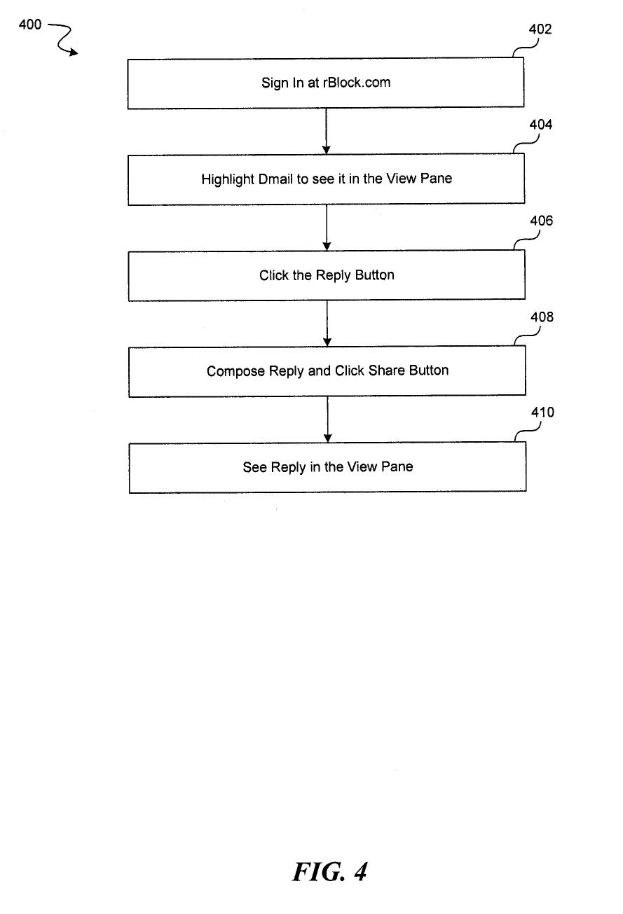

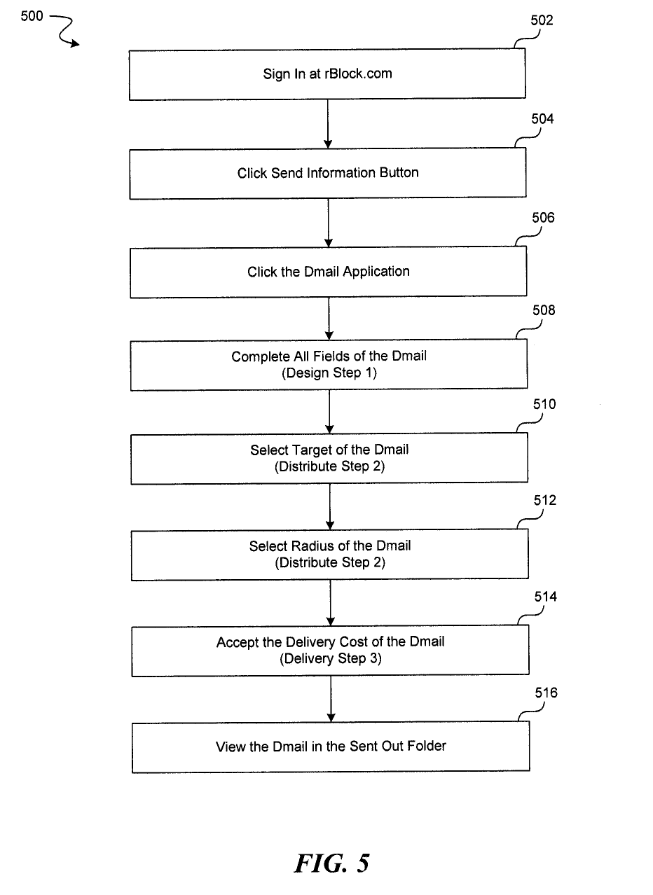

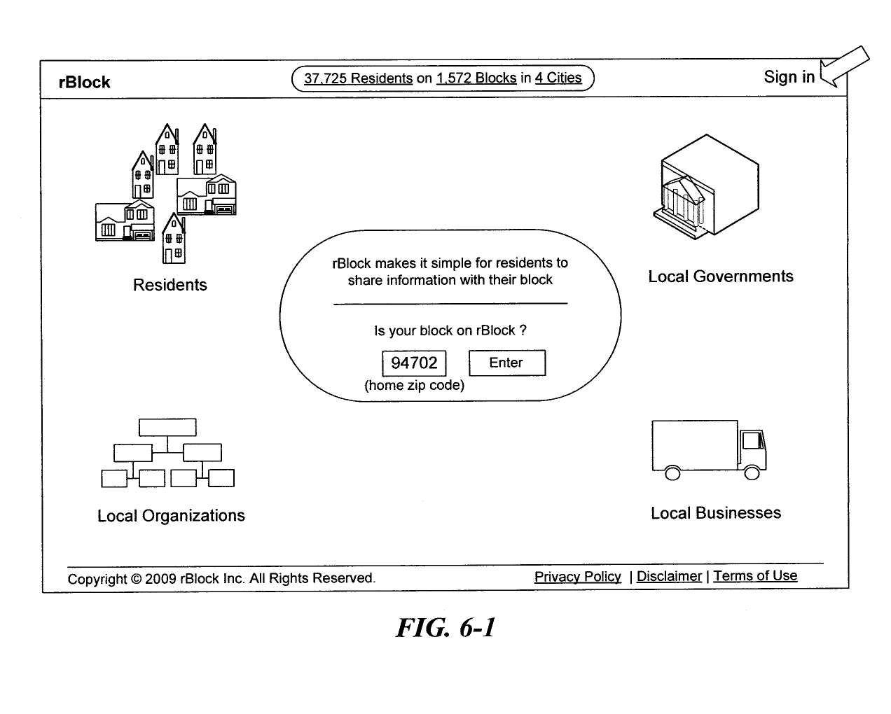

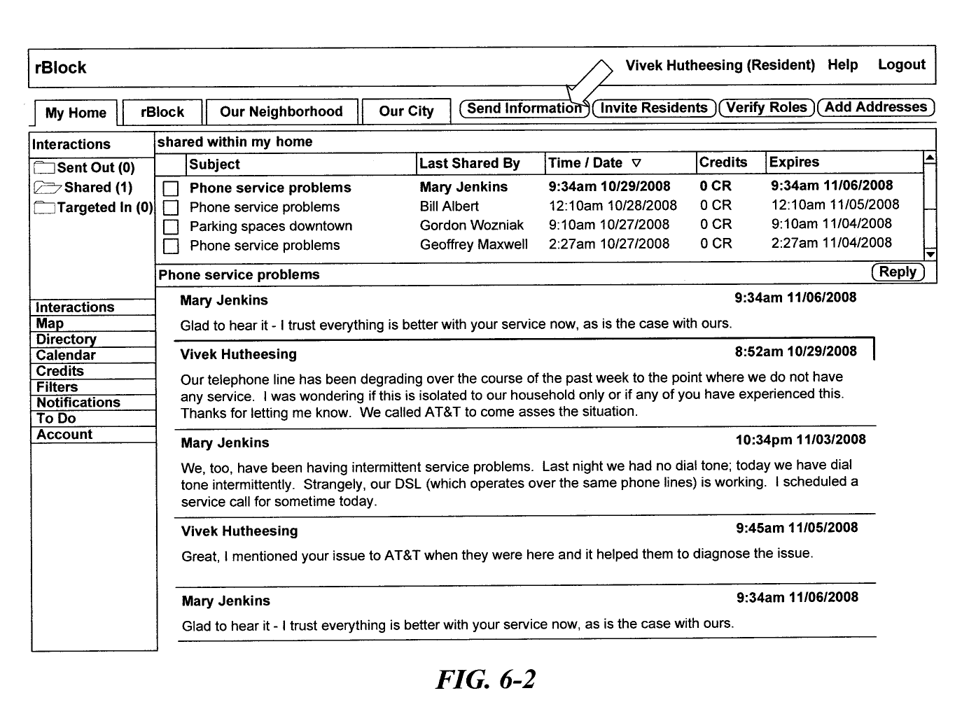

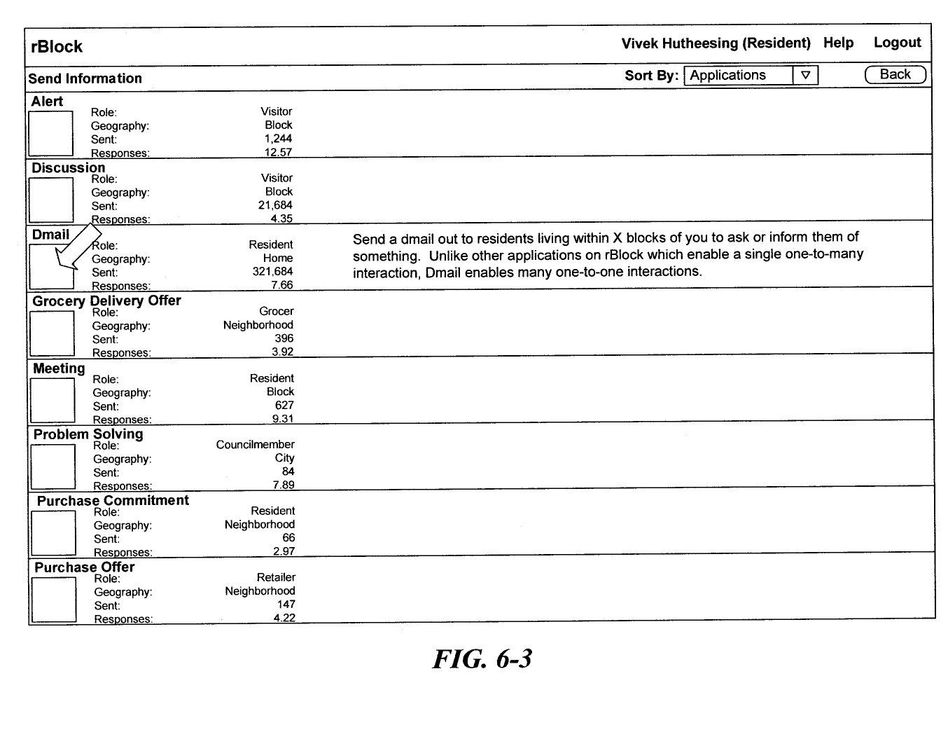

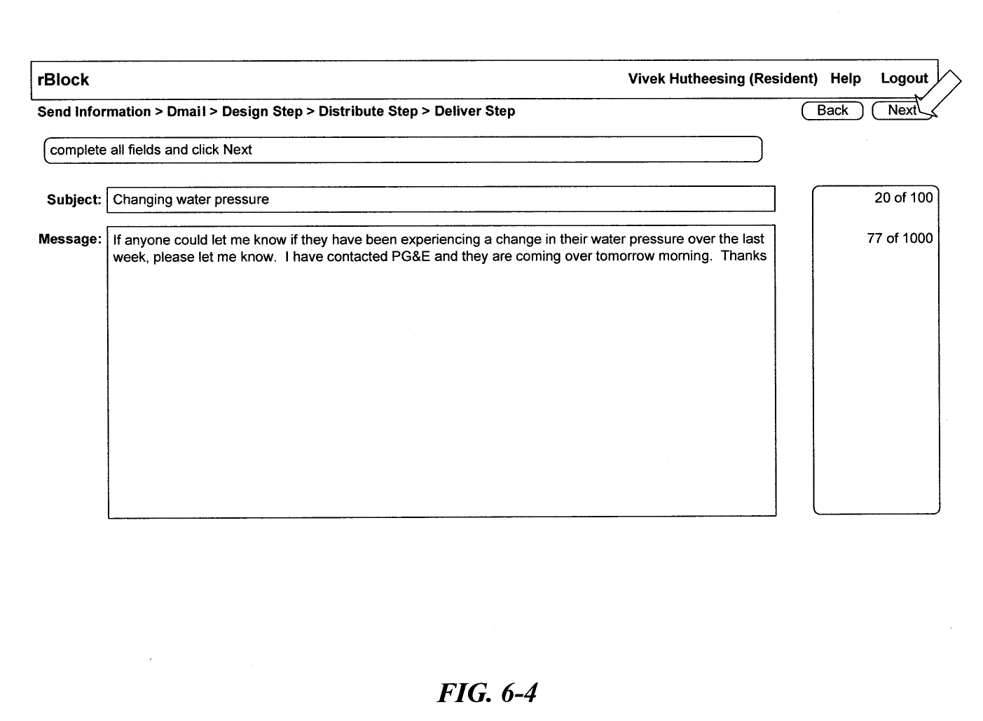

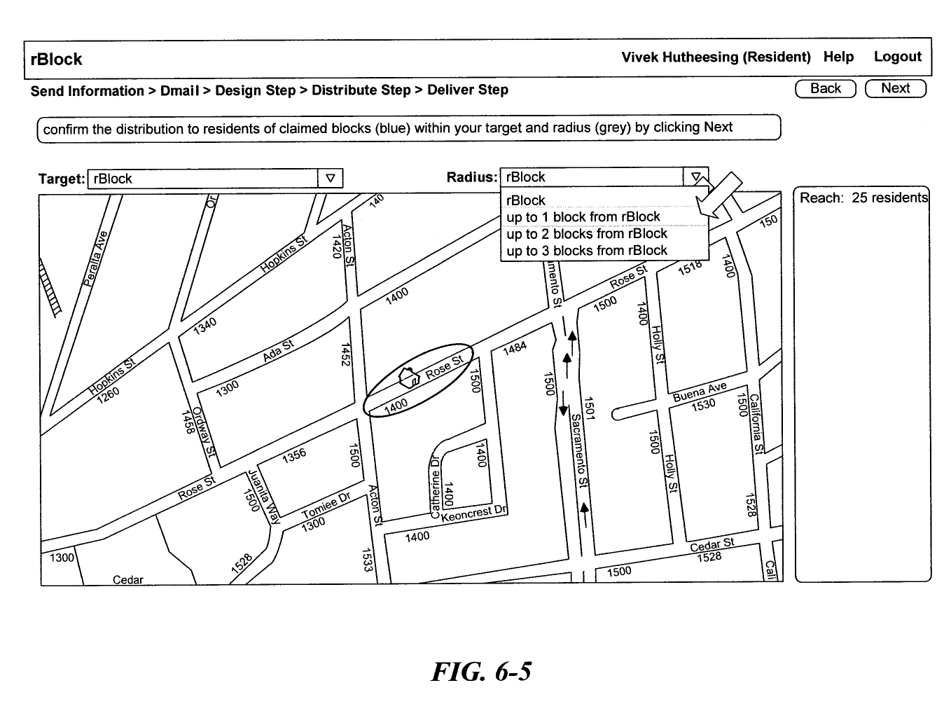

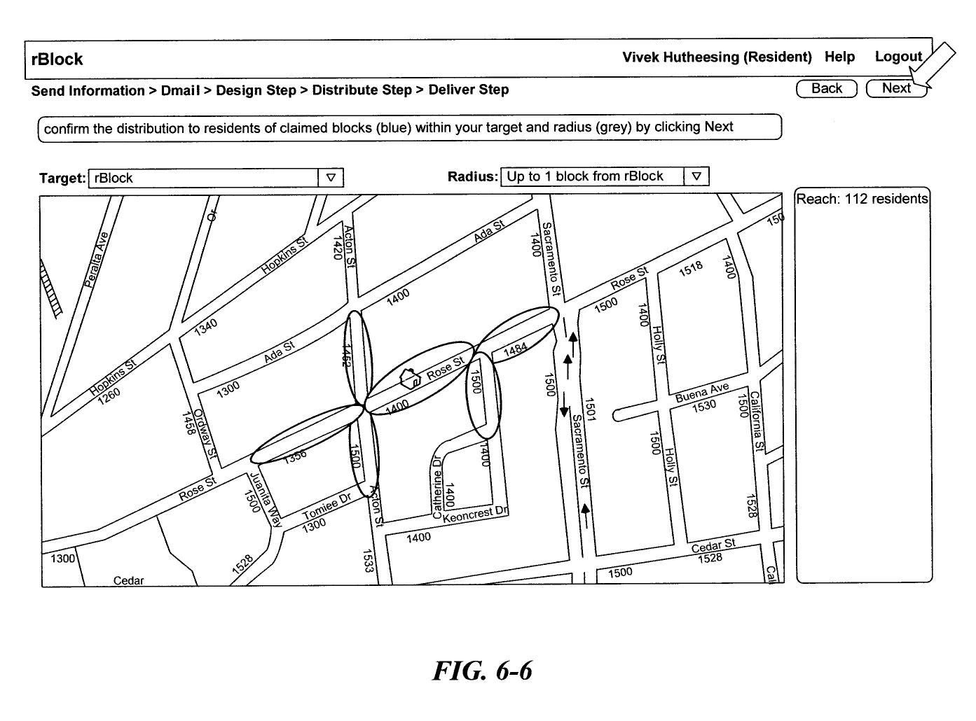

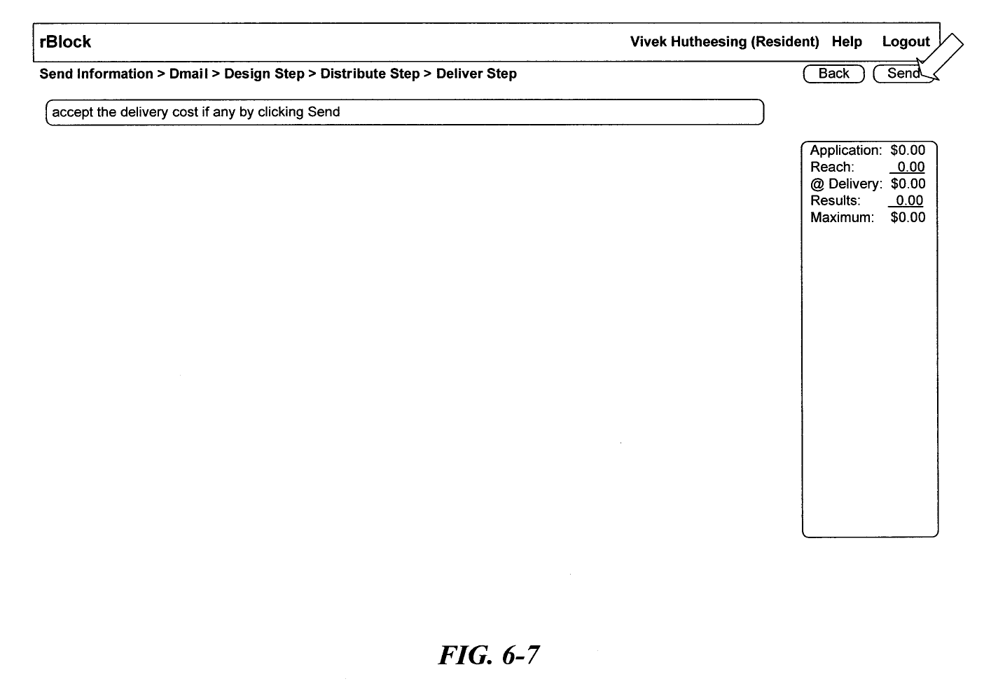

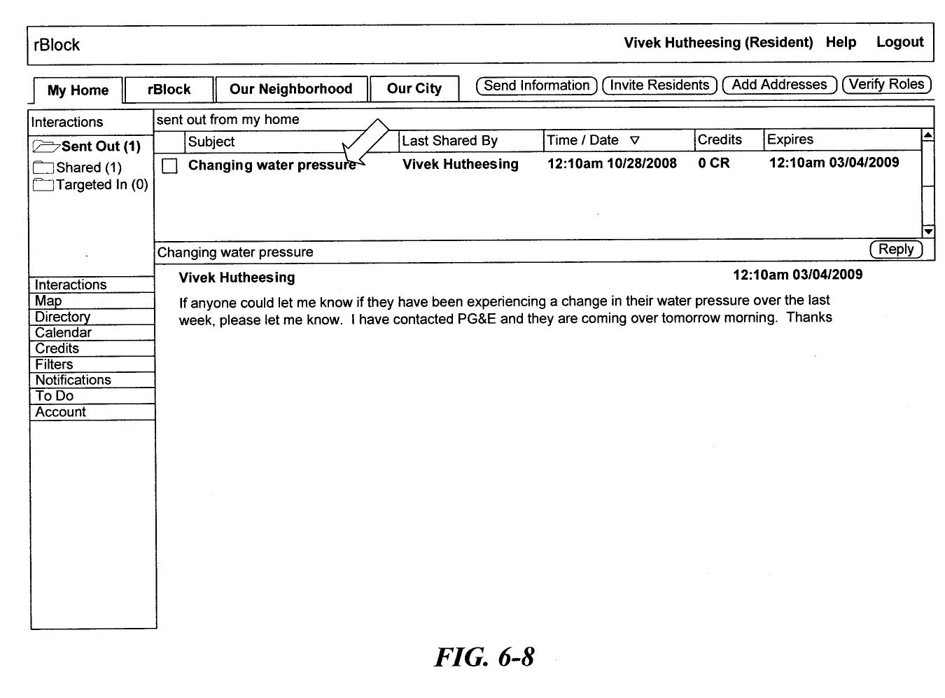

As is the case with all of the flowcharts, prior to Flowchart 100, a user has already registered with the distribution platform and has been verified as a resident living on a particular block. For this reason, as soon as a resident signs in to the distribution platform in step 102 (FIG. 6-1), he/she can click on the Send Information button in step 104 (FIG. 6-2) and select the Dmail application from a list of applications in step 106 (FIG. 6-3). By virtue of knowing where the resident lives, the Dmail application can present a map to a resident that not only highlights his/her particular block but also, upon the resident's selection of a radius, those blocks that are within the radius. In step 108 the resident designs his or her Dmail using steps in one embodiment similar to those used for composing an email—the resident fills out a two-field form that includes a subject header field and a message field. Once the resident completes this design step (FIG. 6-4), he/she then selects in step 110 the radius from, for example, a drop down list that determines how widely his/her Dmail is distributed (FIGS. 6-5 and 6-6). The user then confirms distribution in step 112.

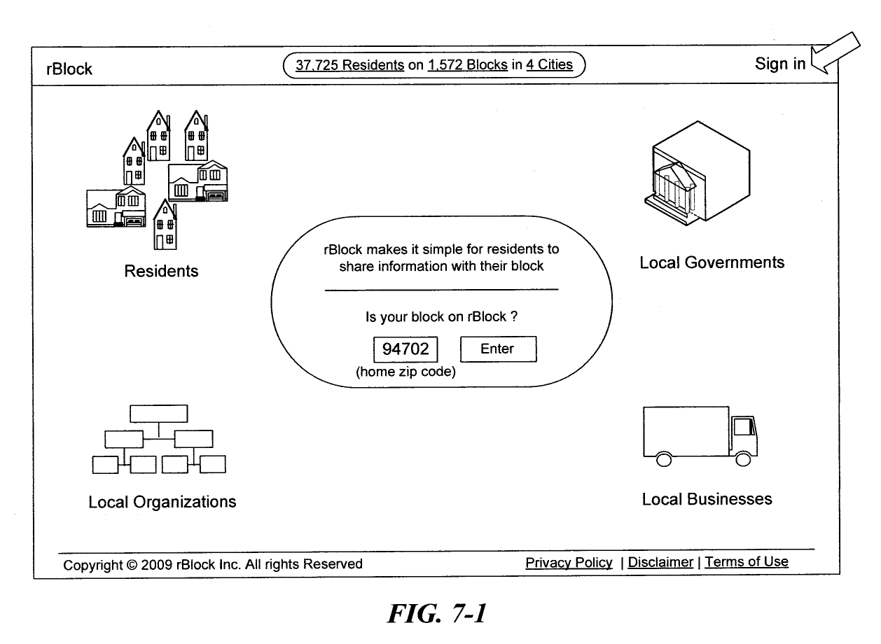

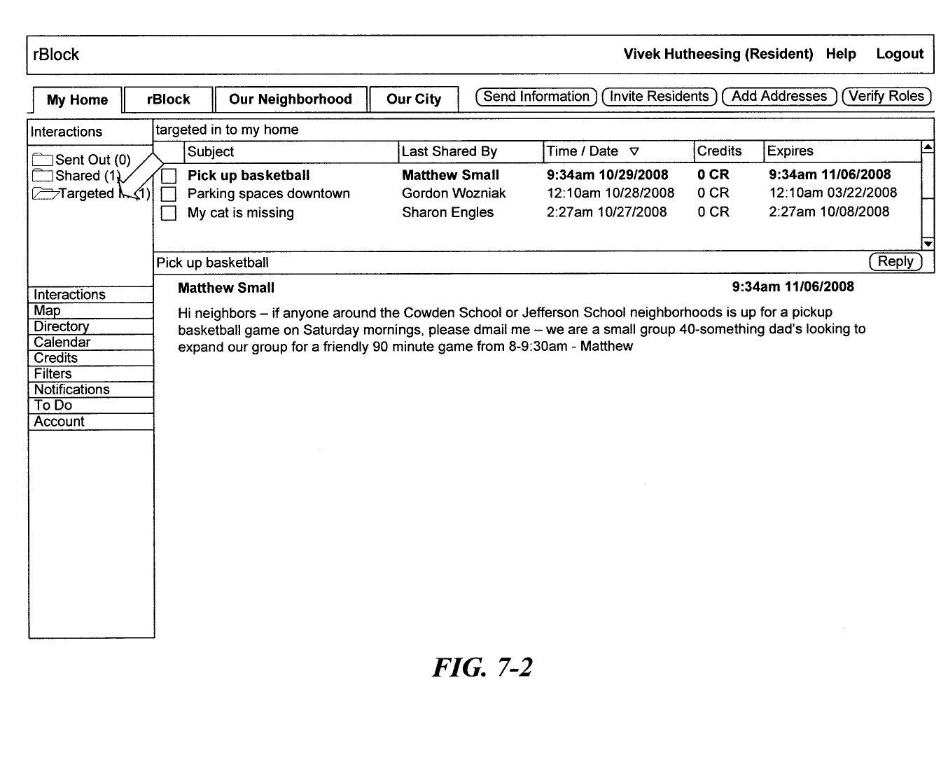

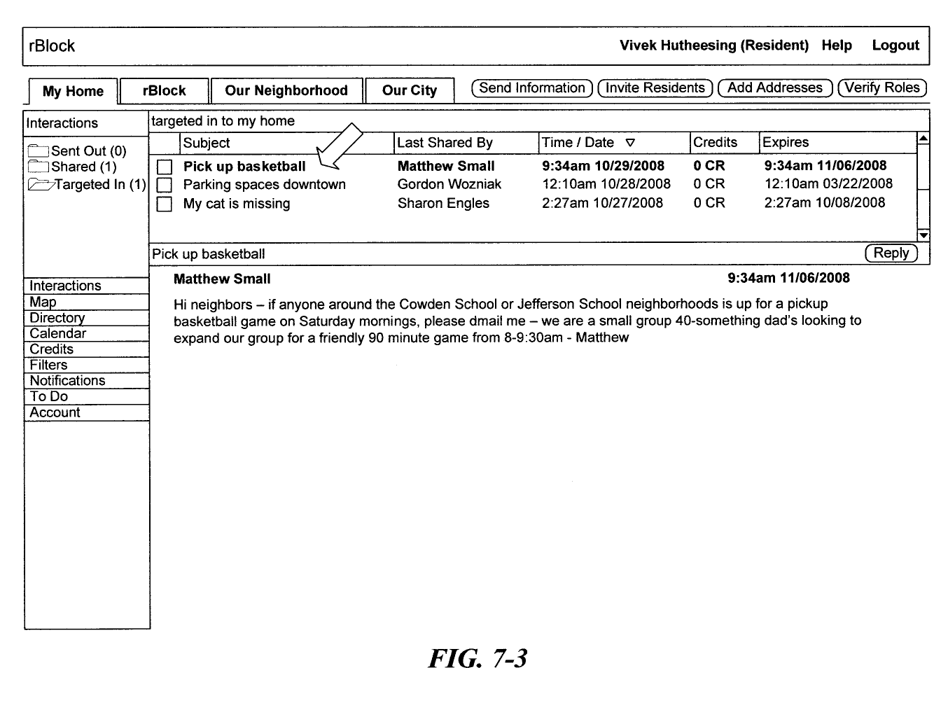

Flowchart 100 continues in step 114 with the resident sending out his Dmail by accepting its delivery cost, if any (FIG. 6-7). The delivery cost may be one of many approaches the distribution platform uses to ensure that Dmails remain relevant, are of high value, and avoid become abusive to their recipients. Upon sending out his Dmail, the user interface re-directs the resident to a view of his sent out Dmail in step 116 (FIG. 6-8).

Unlike conventional email which can be sent to a group of individuals; replied to by each individual recipient to entire original distribution list; forwarded to others, etc., Dmails are in one embodiment private one-to-one interactions between two individuals that cannot be forwarded or unconditionally saved by either side. Instead, in one embodiment they exist for a short period of time until their expiration time and date after which they are automatically deleted. This embodiment is exemplary and not limiting. For example, in another embodiment both the sender and recipient may mutually consent to saving their Dmail interaction until either side withdraws his/her consent. In another example, both the sender and the recipient may mutually consent to extending the expiration time and date of their Dmail interaction. In another example, if either the sender or the recipient loses interest in continuing the interaction, he or she may decide to delete the Dmail interaction prior to its expiration date, causing it to be deleted on both sides. In yet another example, the sender of a Dmail may, in addition to completing the simple two-field form described above, use more complex forms that involve more fields within which to compose sentences, or even more structured ways to capture the sender's content including wikis, radio buttons, time and date scheduling widgets, attendance lists, etc. In yet another example, the sender may also attach files to their Dmail before sending it out, similar to how files are attached to emails.

Flowchart 200 depicts the recipient's side of a Dmail interaction in one embodiment. Just as the sender of a Dmail sees their Dmail as sent out in their Home Tab, the recipients of Dmails see them in the targeted in folder of their Home Tab after step 204 (FIG. 7-2) where they can use their mouse to highlight any particular Dmail that they wish to read below in the interactions pane, in step 206 for example (FIG. 7-3). This creates a value proposition for residents on the distribution platform that is not just user centric but is also resident centric, in one embodiment, such that residents interact with each other not only on the basis of who they are but also on the basis of where they live.

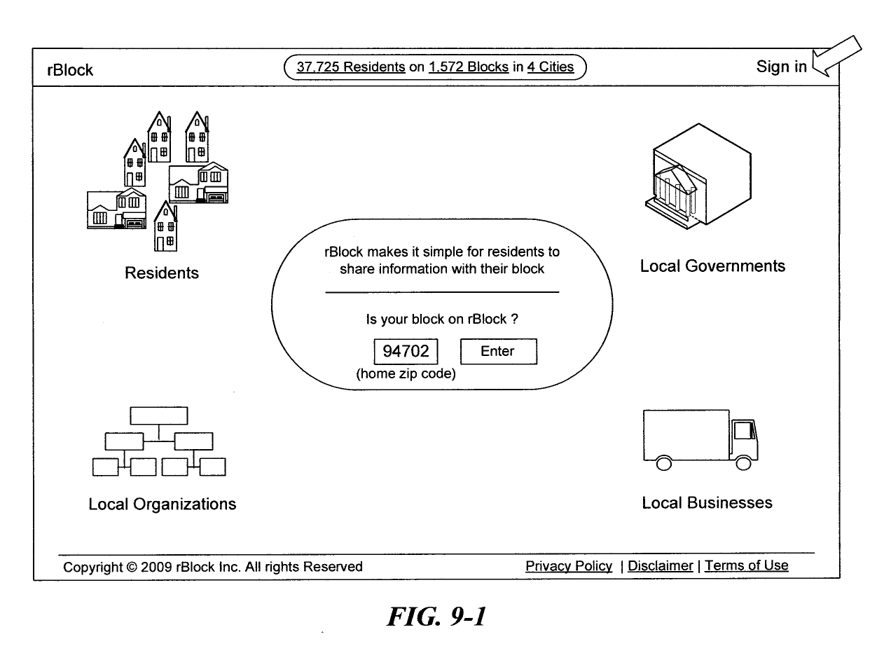

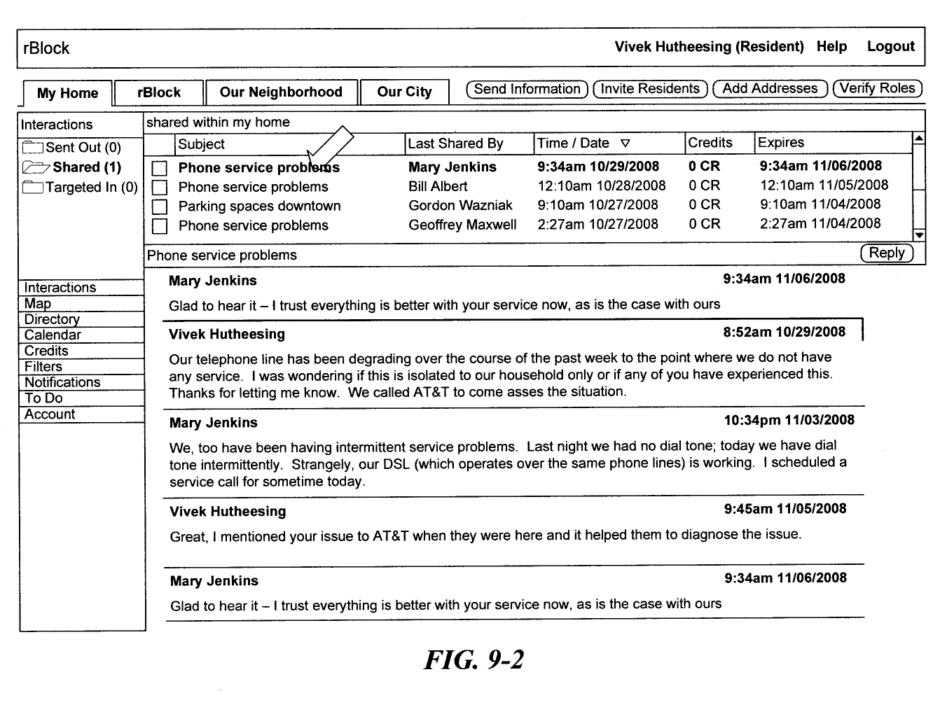

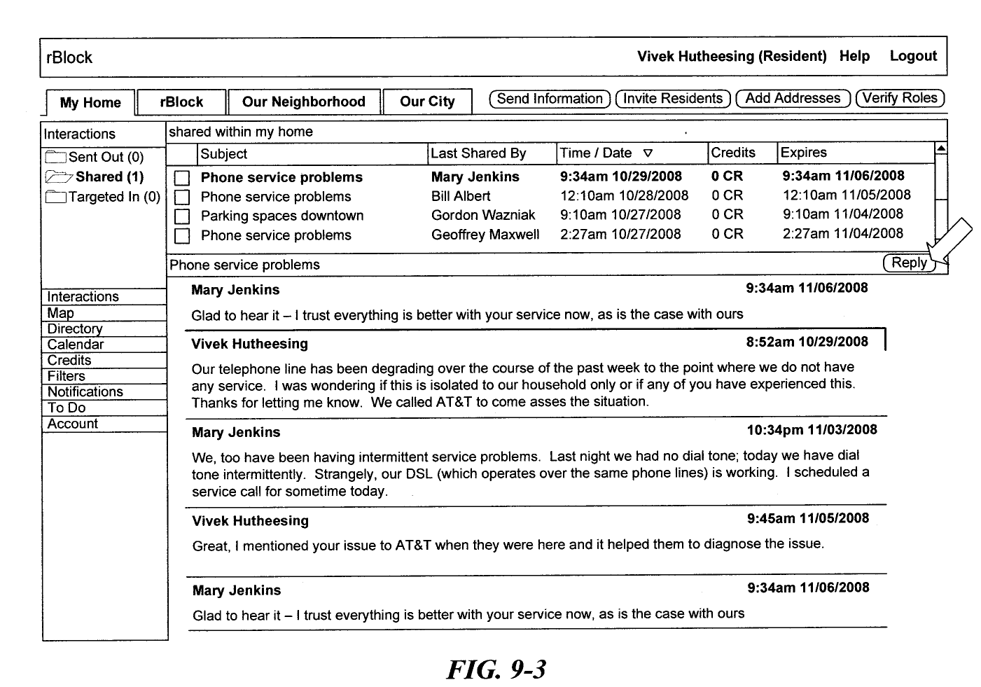

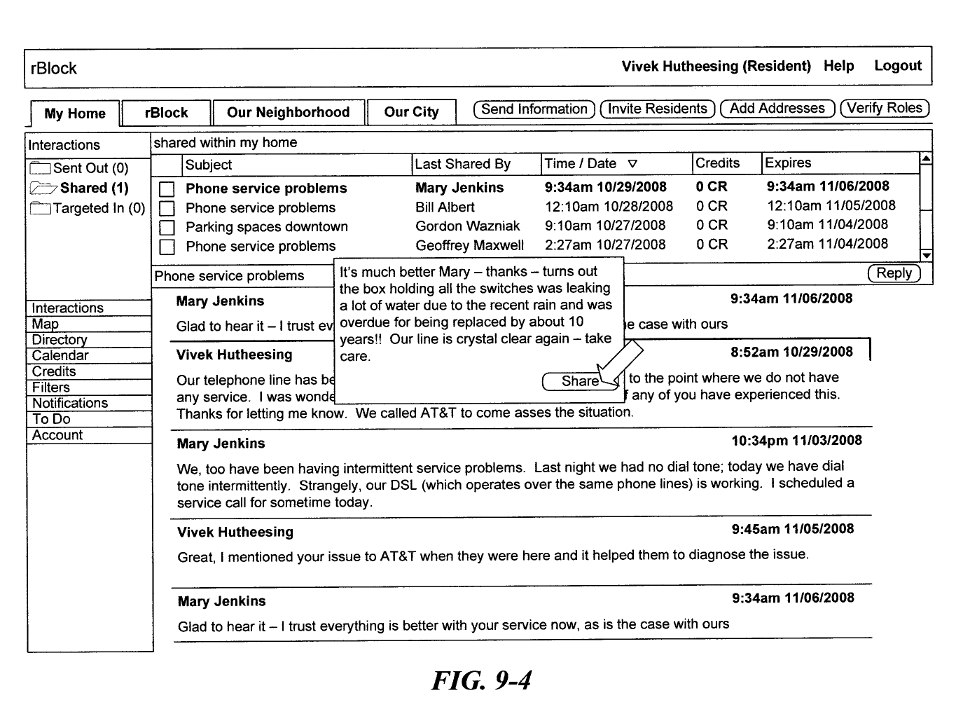

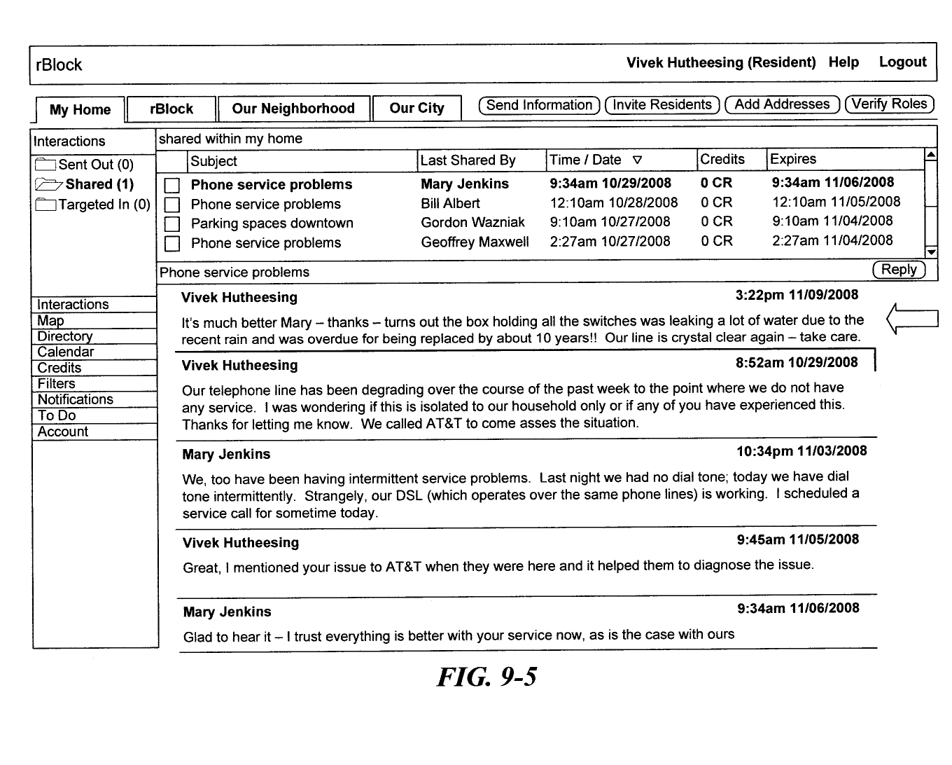

Whether a participant in a Dmail interaction is a sender or a recipient, in one embodiment the interaction moves to the participant's shared folder—(FIG. 9-2) as soon as the sender has responded to the recipient—now it is a shared interaction that, as mentioned above, features in the list view until it expires. The list view of all folders—sent out, shared, targeted in—displays Dmail interactions by date unless the resident chooses to resort the list view by any one of the other columns of information shown.

In one embodiment, whether a Dmail interaction appears in the sent out folder, the shared folder, or the targeted in folder, its sender or its recipient may click it to highlight it in the list view pane (upper half of screen). This enables them to see the interaction's content in the interactions pane (lower half of screen).

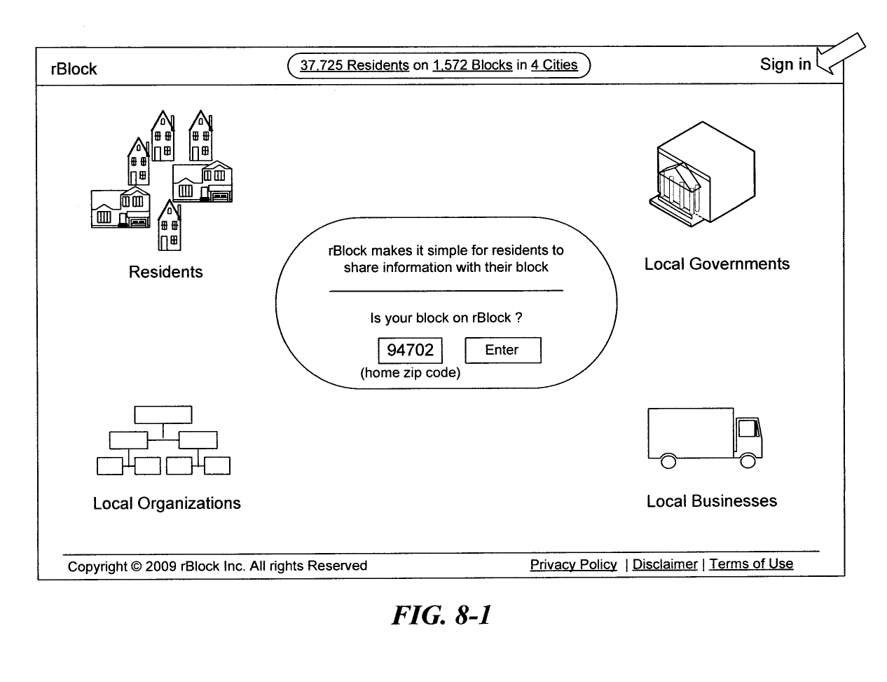

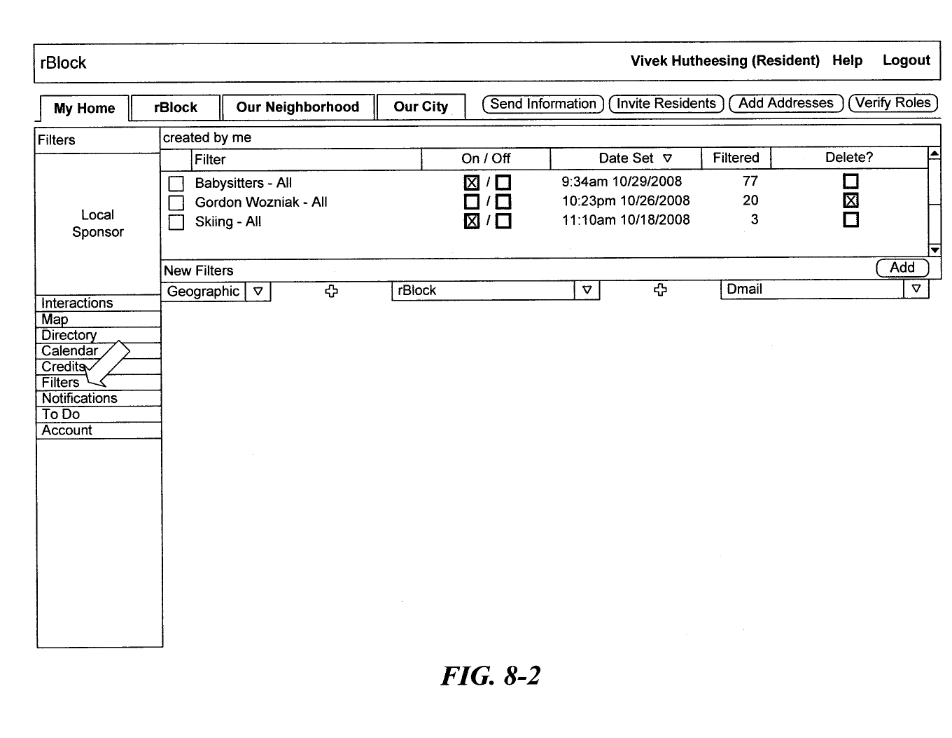

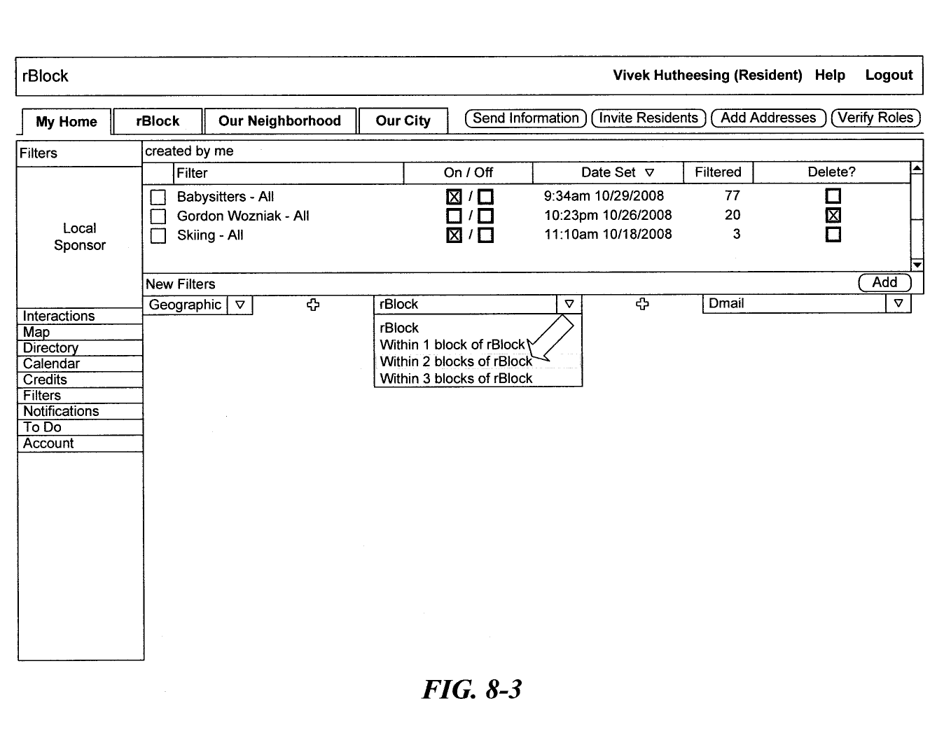

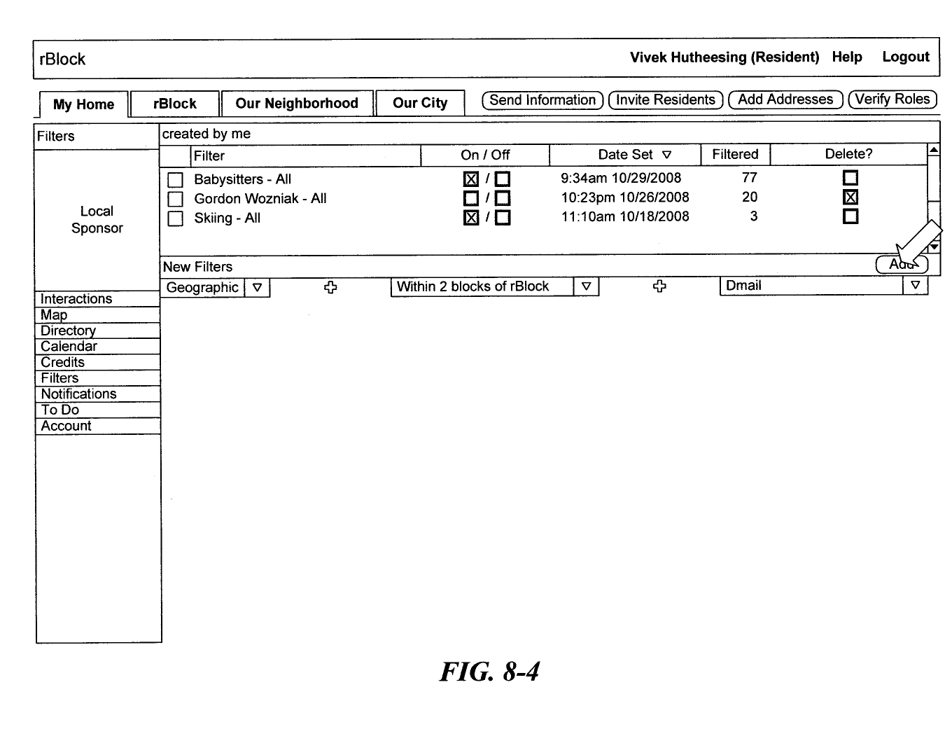

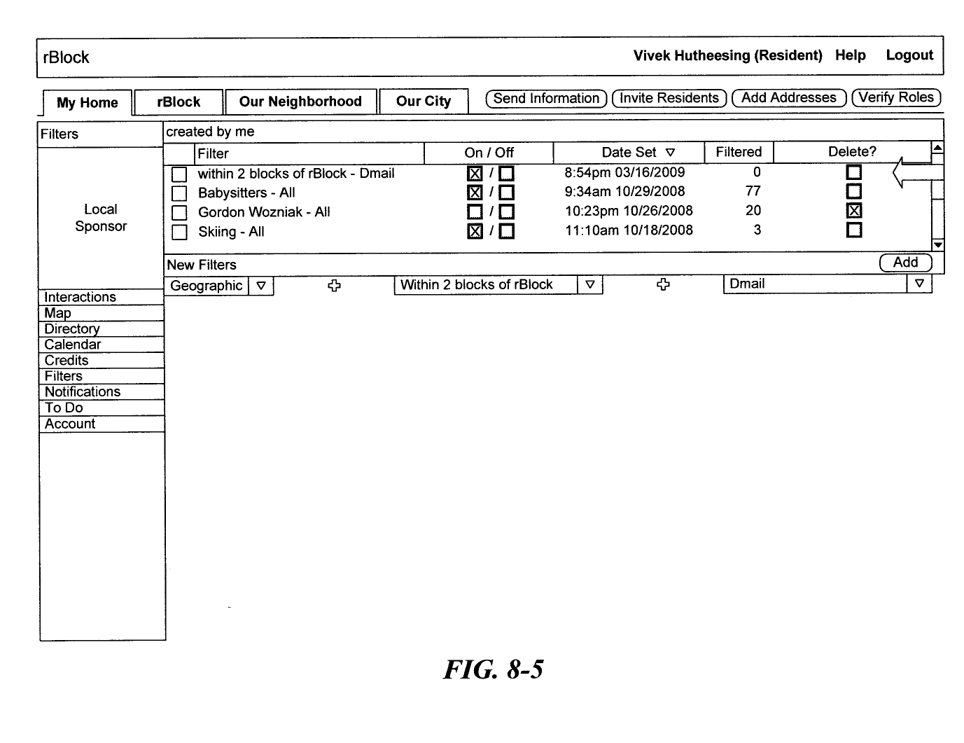

Flowchart 300 depicts the recipient's side of a Dmail interaction, in one embodiment, and describes how a recipient can create filters to limit the scope of the Dmails that he/she receives (FIG. 8-2). The distribution platform may provide residents with three exemplary types of filters—geographic, people-based and interest-based. Recipients may use dropdown menus to design the filters they create, as shown in steps 302, 304, 306, 308, and 310. The example in Flowchart 300 shows a resident can create a geographic filter (FIG. 8-3). The new filter added effectively filters in any future Dmails from senders who live within 2 blocks of the recipient (FIGS. 8-3, 8-4 and 8-5). This embodiment is exemplary and not limiting. One ordinarily skilled in the art will recognize that filters may enable many types of restrictions in a way that maintains and/or increases the relevance of the information received by any recipient. For example, a resident may wish to receive Dmails from everyone who lives within 2 blocks of where he/she lives. But at the same time, the resident may receive a wider radius of interactions with respect to other applications on the distribution platform. For example, a more specialized application that, like Dmail, enables multiple one-to-one interactions, might be called Ride Offer. And while a resident may wish to only receive Dmails within a 2 block radius, he/she may also wish to receive ride offers from senders who live within 5 blocks of where he/she lives. The resident can achieve this by creating another geographic filter for the Ride Offer application that specifies a 5 block radius.

In one embodiment, another important aspect of setting the radius of filters falls under the principle of reciprocity. If, for a particular application, a resident creates a filter of up to 7 blocks, for example, from the distribution platform in order to restrict the radius of senders who use that application to reach him/her as the recipient, then the radius restriction also applies to his/her use of that application as the sender. So filters may be designed to not only limit the radius of what is targeted in but also to limit equally the radius of what is sent out. In other words, when filters are applied to applications like Dmail, they give equal reach to both the senders and the recipients of those applications. For example, a resident who has set a geographic filter so that he/she receives Dmails that are sent out within 2 blocks of the distribution platform (FIG. 8-5) can himself/herself only send out Dmails to recipients who are up to 2 blocks away.

Flowchart 400 depicts the recipient's side of a Dmail interaction and describes how a resident can respond to a Mail that he/she has received. Similar to email, the response is initiated in step 406 by hitting the reply button which opens a form field for composing the reply (FIG. 9-3). The resident then hits the share button in step 408 which adds their response to what is now a growing thread of interactions between the sender and the recipient (FIG. 9-4). The button is called a share button to indicate that the first response has now created an interaction that will remain in the shared folder of both the sender and the recipient until the expiration time and date. So the recipient can always send at least one reply to the sender, and often a much longer thread develops over time (FIG. 9-5). The sender may then view the reply in step 410.

In one embodiment, by virtue of having received the Dmail, the recipient has the ability to respond to the sender, provided that the recipient does so prior to the expiration time and date, if an expiration time and date have been set. This right of recipients to respond stems from a system design that makes their response a right, again, so long as their response is shared prior to the Dmail's expiration time and date. The right is enabled by only having the delete button in the shared folder. So if the sender sends out a Dmail to 150 residents on the distribution platform who live up to 2 blocks from the distribution platform, he or she has already conferred to each of those 150 the right to a private response, and he/her could theoretically receive up to 150 responses that create 150 private one-to-one interactions in his/her shared folder. A recipient's reply may be shared only with the original sender—it cannot be forwarded to others—nor can the original sender forward the interaction with the recipient to others. Therefore the Dmail interaction remains a private, one-to-one interaction between its sender and recipient.

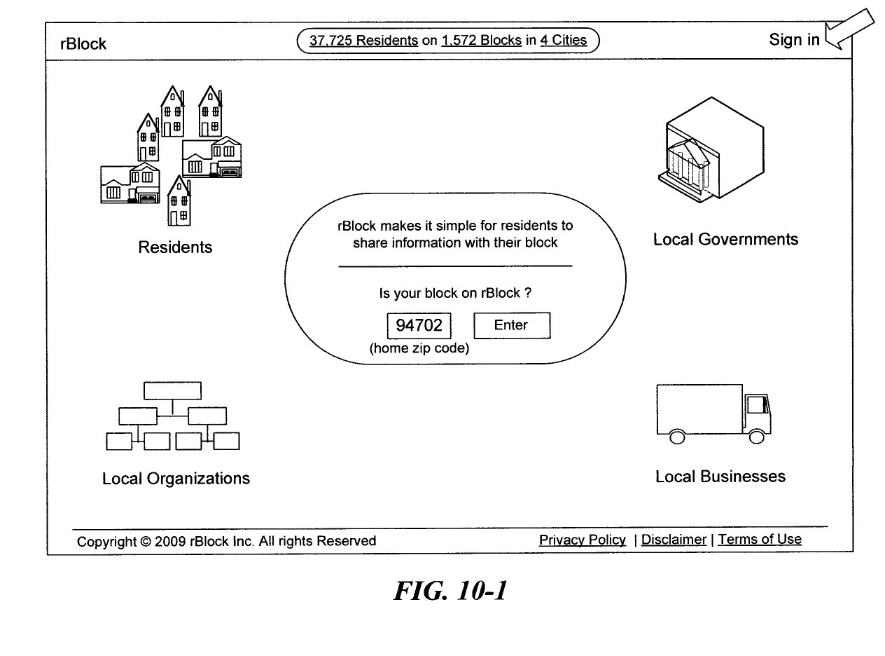

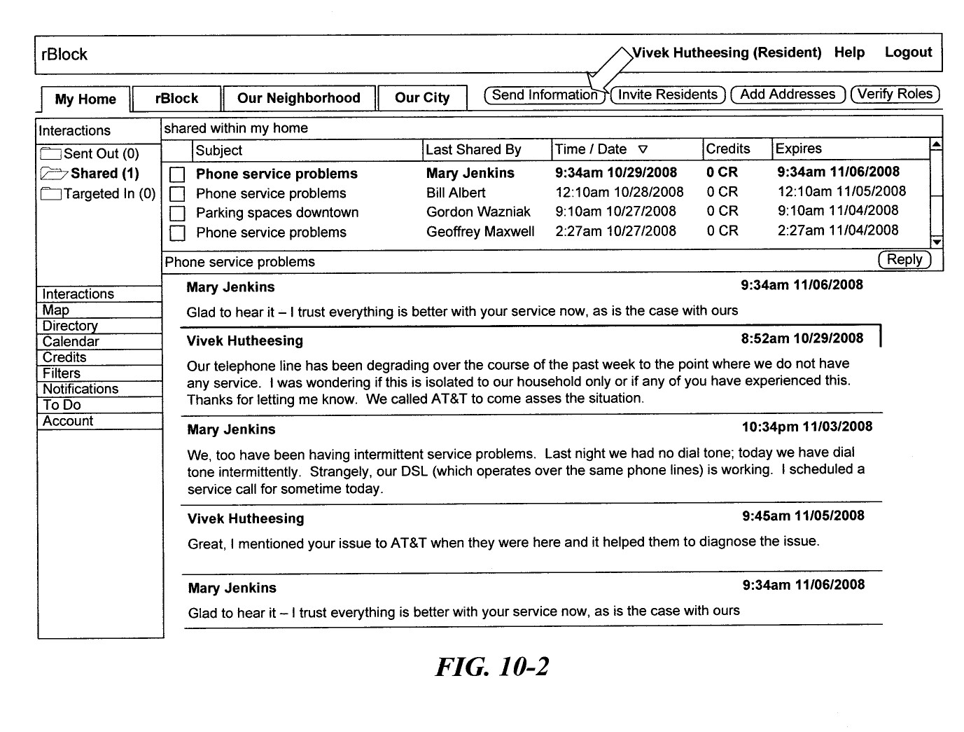

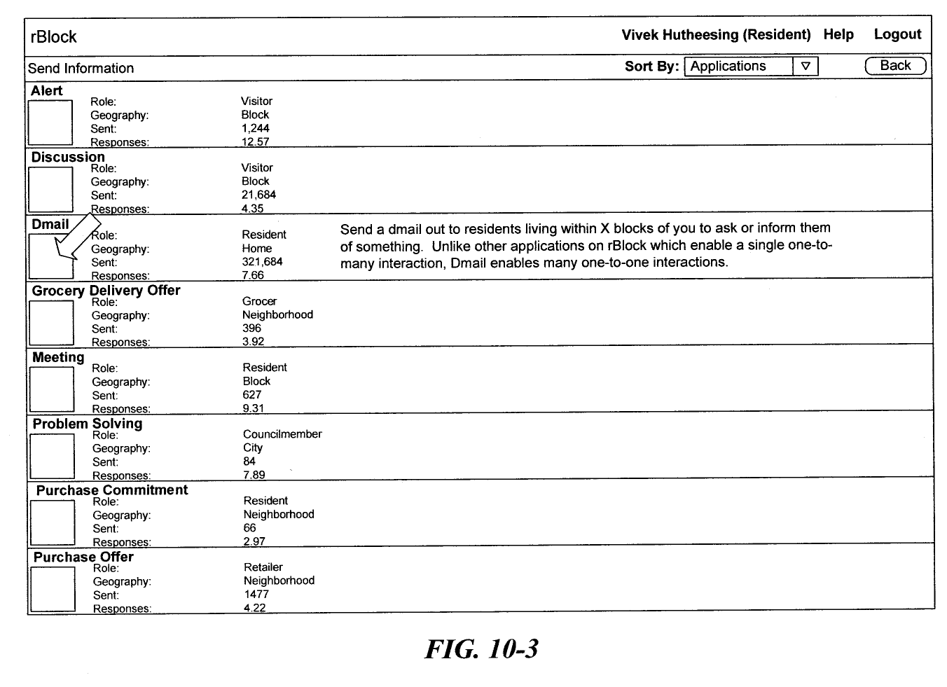

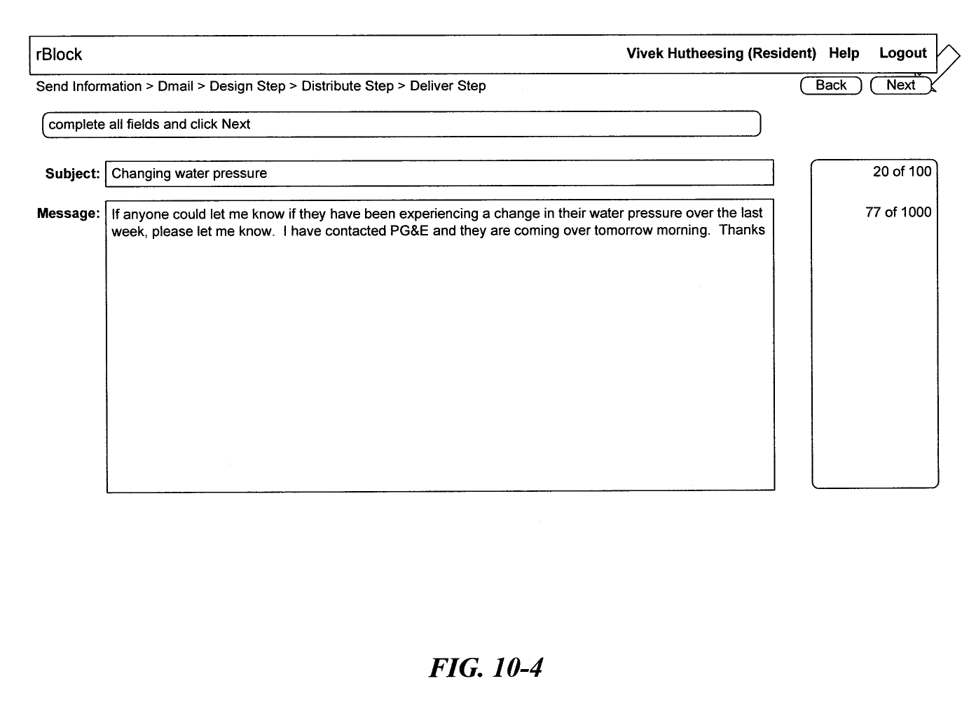

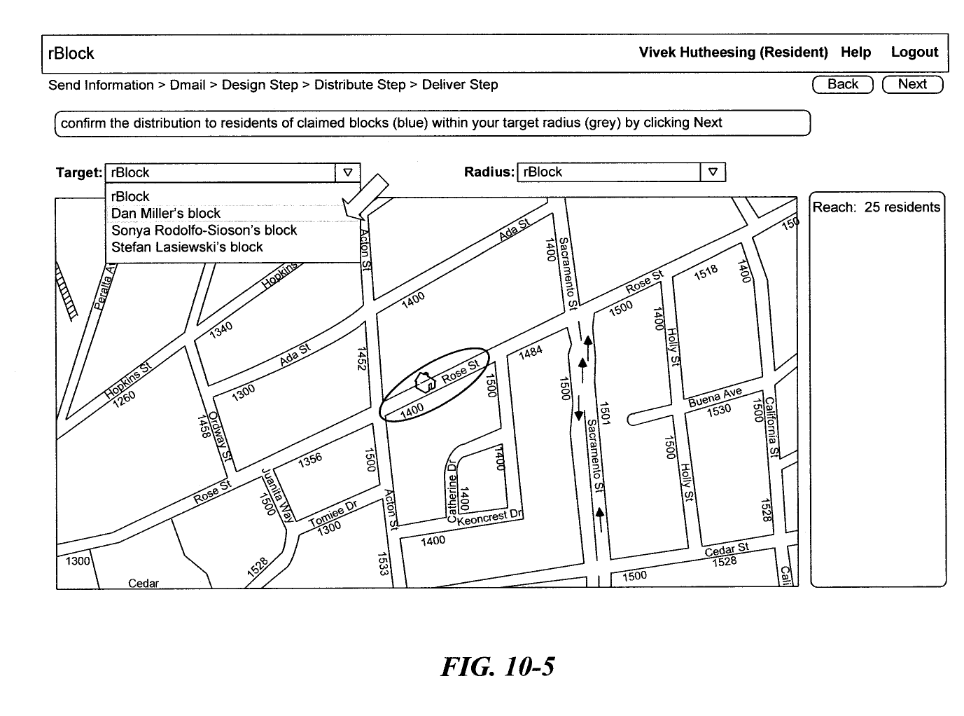

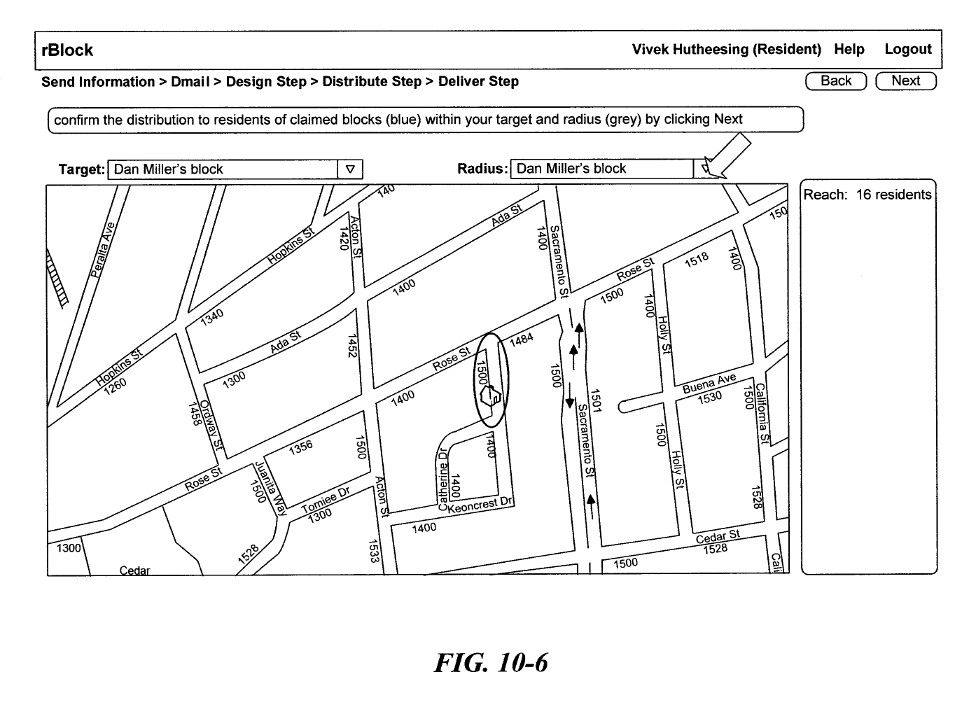

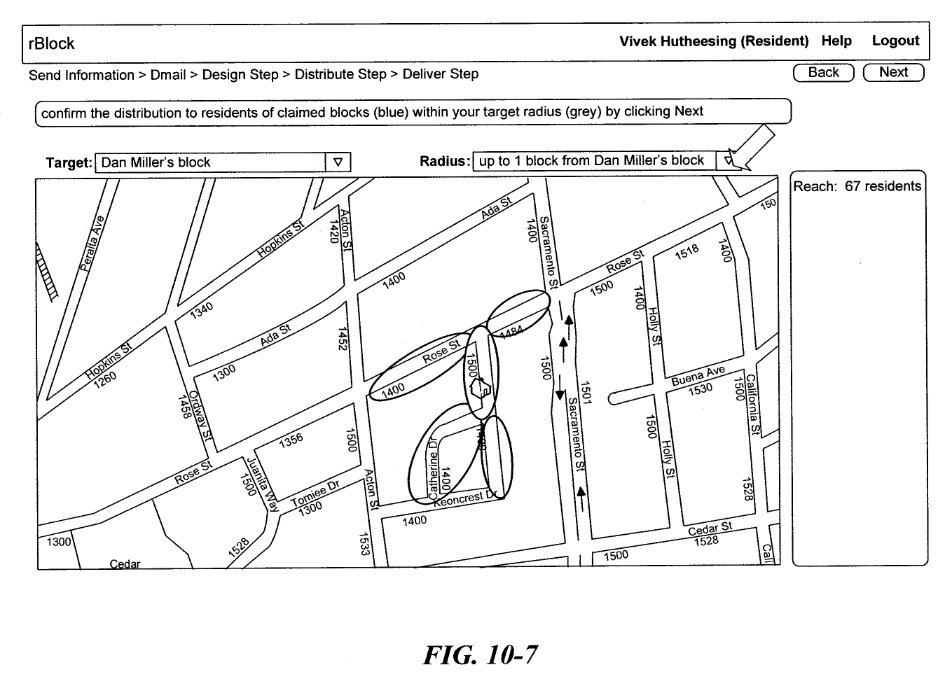

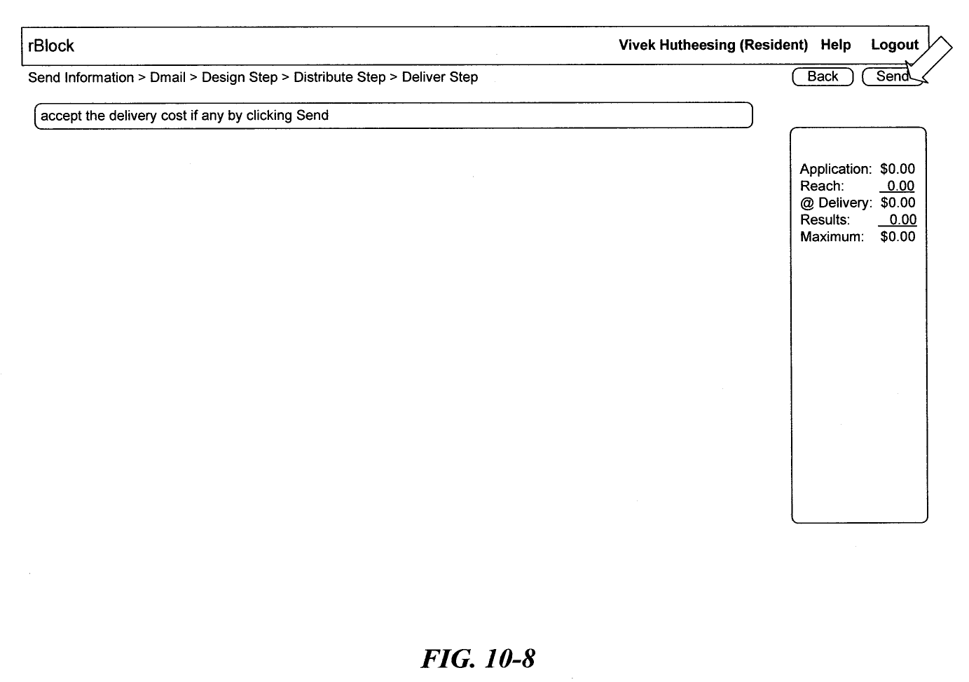

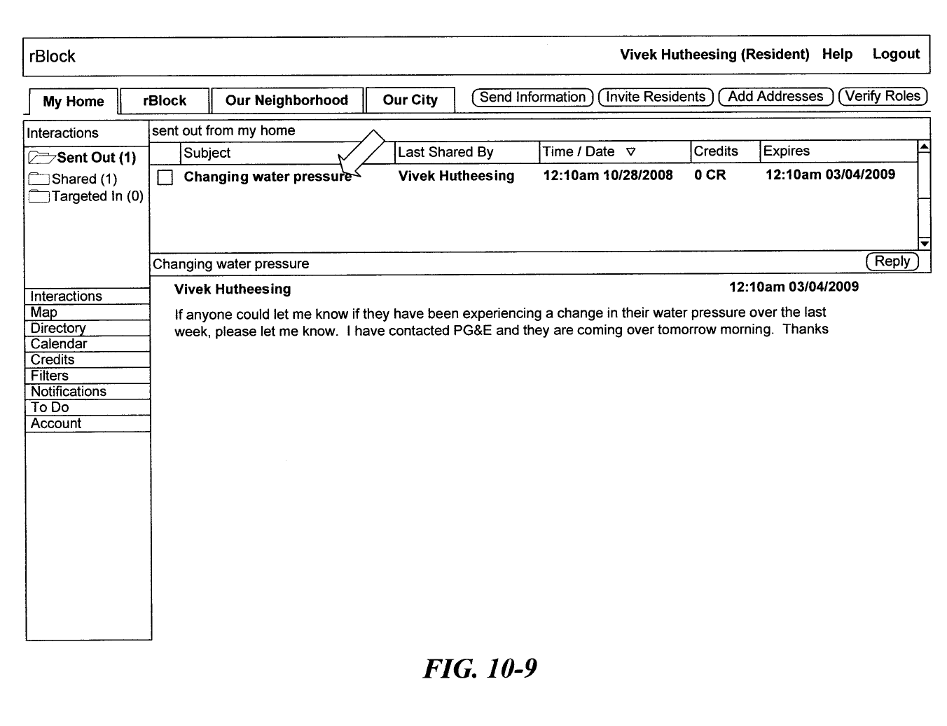

Flowchart 500 depicts another method for a sender of a Dmail to design and distribute information. The method begins in a manner similar to flowchart 100. The resident clicks the send information button in step 504 (FIG. 10-2) and selects the Dmail application in step 506 (FIG. 10-3). However instead of sending out a Dmail from his/her own block to a pre-defined radius of recipients who live near to it, the resident sends out a Dmail (composed in step 508) to a target block (a block other than his or her own block) and include a pre-defined radius of residents who live near the target block as its recipients. In this case, the resident sending out the Dmail must specify both a target in step 510 (i.e. target block) and a radius in step 512, rather than just a radius as has been the case in the earlier examples cited. This embodiment is exemplary and not limiting. For example, in one embodiment, after designing their Dmail (FIG. 10-4) the resident may define the target block for his/her Dmail by using a dropdown list to select any eligible contact, say Dan Miller for example, whose block is to be the target block (FIGS. 10-5 and 10-6). The resident then selects the radius from Dan Miller's block that will receive his/her Dmail (FIG. 10-7). He/she then accepts the delivery cost in step 514, if any, sends out his/her D)mail, and is re-directed to where his/her Dmail is shown as sent out (FIGS. 10-8 and 10-9).

In other embodiments, the sender may use a map navigator to navigate to a block which he/she selects as the target block. In yet another embodiment of how a sender might identify the target block for his/her Dmail, the sender might use an optimizer that enables him/her to select a target block that maximizes the reach of his Dmail (i.e. the number of recipients), given various constraints that may or may not be known to the sender of the Dmail. One constraint that would be known to the sender would be his/her filter settings that, as mentioned earlier, restrict a sender's reach to the area from which the sender is willing to receive, or filter in, Dmails. For example, if a sender had a Dmail filter that enabled them to only receive Dmails from residents living up to 10 blocks away from the distribution platform, then selecting a target block that is 9 blocks away from where they live would limit the radius they could then select to up to 1 block from target block so as to maintain the restrictive nature of Dmail interactions. Another constraint that might not be easily known to the sender is how many residents, who live within the area he/she wishes to target a Dmail to, are users of the distribution platform. The number of residents on the distribution platform is easily discernable for a sender who is simply sending out a Dmail from where they live, but it is less easy to discern, other than by trial and error, who many residents within another target block are users of the distribution platform, hence the value of an optimizer. Finally, in another embodiment, a sender might select a target block for his/her Dmail could involve making the choice based on anonymized information about the block, its residents, or the type or volume of content in the block's private interactions.

From the perspective of a Dmail recipient, receiving a Dmail from a sender who has selected both a target block (again, a block other than his own block) and a radius, as opposed to just a radius, is identical. The recipient sees the new Dmail in his/her targeted in folder and can reply to it prior to its expiration time and date, making it an interaction that appears in the shared folder of both the sender and the recipient.

In one embodiment, the Dmail interactions are possible for two reasons that have to do with the Filter settings of both the sender and the recipient. In the case where the sender has sent out a Dmail from their own block, the recipient lives close enough to the sender so as to be within the radius of any filters the sender and the recipient may have set for receiving Dmails. In the case where the sender has sent out a Dmail from a target block, the recipient lives close enough to both the sender and the sender's target block so as to again be within the radius of any filters the sender and the recipient may have set for receiving Dmails. So in the second case, the Dmail interaction is more targeted.

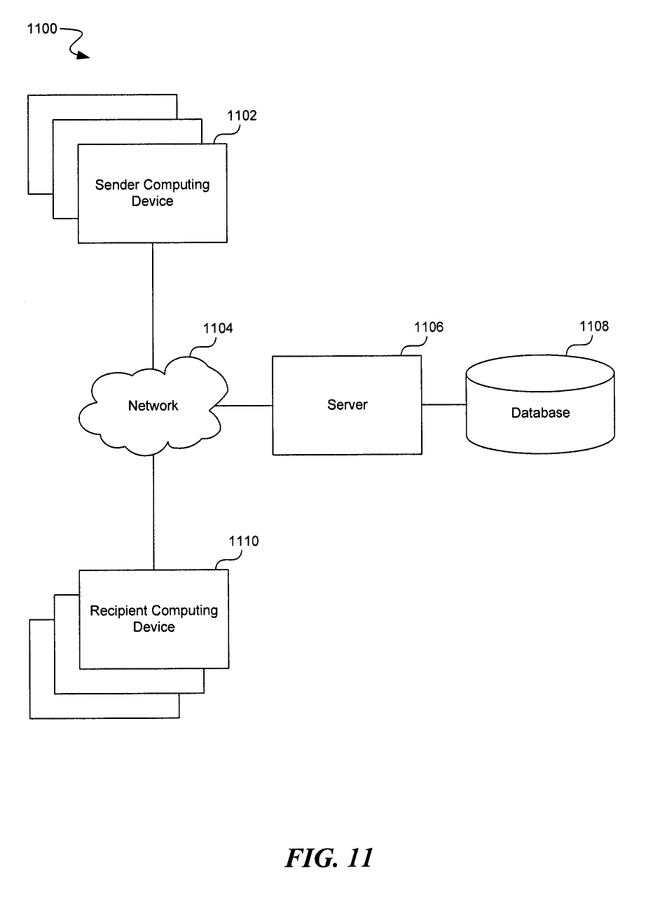

FIG. 11 depicts an example of a system for distance based content distribution. FIG. 11 includes sender computing device 1102, network 1104, server 1106, database 1108, and recipient computing device 1110.

In the example of FIG. 11, the sender computing device 1102 can include, in various embodiments, a desktop or laptop computer, a personal digital assistant (PDA), a mobile phone, or another device configured for communication with network 1104. Recipient computing device 1110 can include, in various embodiments, a desktop or laptop computer, a PDA, a mobile phone, or another device configured for communication with network 1104. Network 1104 can include, for example, a local area network, a wide area network, a combination of networks, or the Internet. Server 1106 is, in one embodiment, a computer having a processor and a memory, configured to execute software for distance based content distribution. Further, server 1106 is configured for communication with network 1104 and with database 1108. Database 1108 is, in one embodiment, a database executing on server 1106, while in another embodiment database 1108 is a database executing separately from server 1106. Database 1108 is configured, in one embodiment to store user information and other information for distance based content distribution.

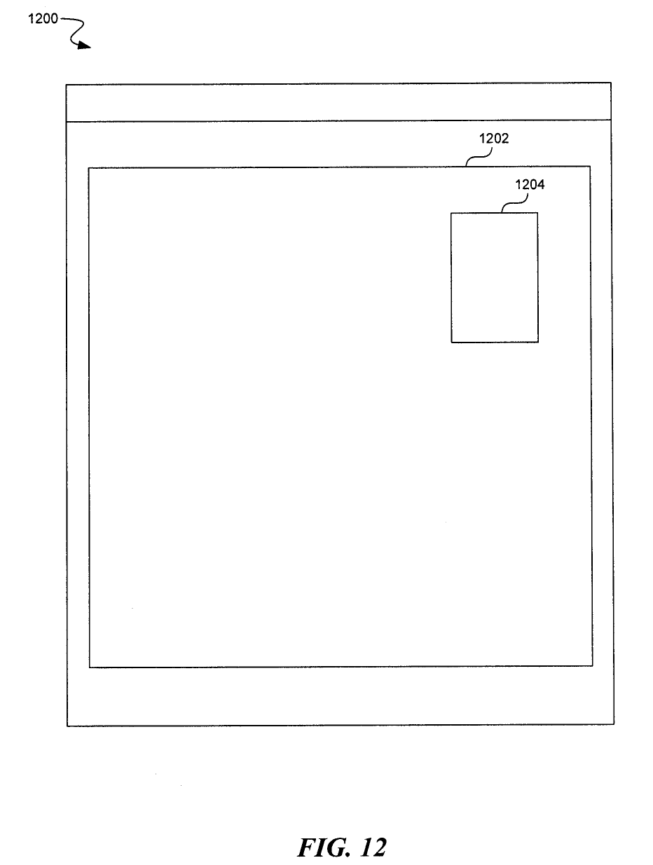

FIG. 12 depicts an example of a method for providing incentives for users to join the distribution platform. In one embodiment, user participation in an exemplary Dmail system can be encouraged by providing registration incentives to potential users. Registration incentives can be provided to potential users by, for example, local governments, local organizations, or local businesses. A local business, for example, may provide a registration incentive to a potential user of the Dmail system via a link 1204 on a website 1202 of the local business. In particular, when a user of the distribution system places an order at a supermarket, for example, the distribution system or the user placing the order may send a Dmail to nearby users of the distribution system to inform them of that order. This may reduce the cost of the delivery for each individual if orders from different users are combined. The supermarket might also publish a notice 1204 on their website 1202 that deliveries are being made from the supermarket to a particular neighborhood. Potential users may visit the website, read the notice, and follow a link included in the notice to a distribution system registration website. Thus, the potential users may register, and may begin participating with other users with neighborhood deliveries from the supermarket, coordinated through the Dmail system.

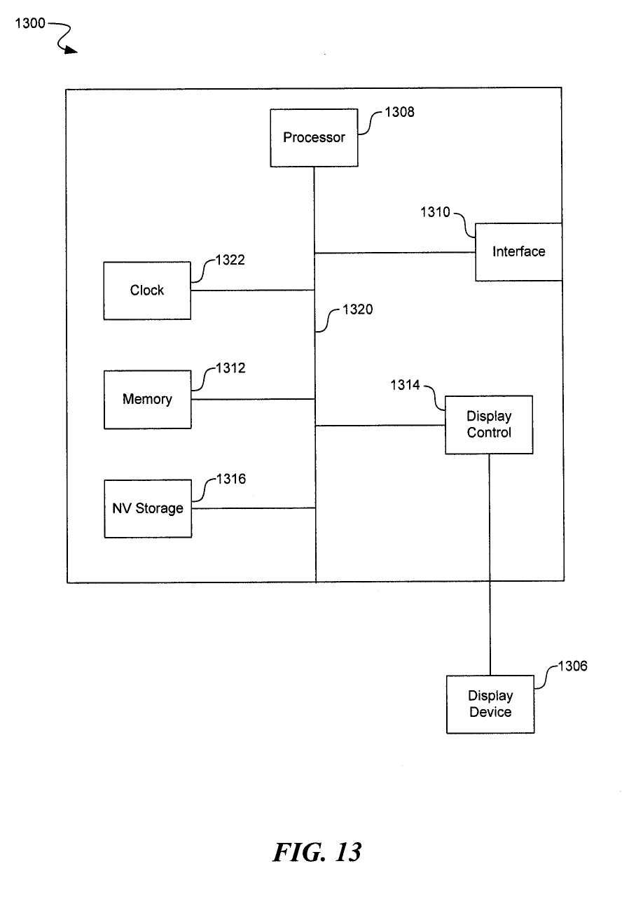

FIG. 13 depicts an example of a system 1300 for a distance-based content distribution system. The system 1300 may be a conventional computer system that can be used as a client computer system, such as a wireless client or a workstation, or a server computer system. The system 1300 includes a device 1302, and a display device 1306. The device 1302 includes a processor 1308, a communications interface 1310, memory 1312, display controller 1314, non-volatile storage 1316, clock 1322. The device 1302 may be coupled to or include the display device 1306.

The device 1302 interfaces to external systems through the communications interface 1310, which may include a modem or network interface. It will be appreciated that the communications interface 1310 can be considered to be part of the system 1300 or a part of the device 1302. The communications interface 1310 can be an analog modem, ISDN modem or terminal adapter, cable modem, token ring IEEE 802.5 interface, Ethernet/IEEE 802.3 interface, wireless 802.11 interface. satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface. Enhanced GPRS (EDGE/EGPRS), High-Speed Downlink Packet Access (HSPDA) interface, or other interfaces for coupling a computer system to other computer systems.

The processor 1308 may be, for example, a conventional microprocessor such as an Intel Pentium microprocessor or Motorola power PC microprocessor. The memory 1312 is coupled to the processor 1308 by a bus 1320. The memory 1312 can be Dynamic Random Access Memory (DRAM) and can also include Static RAM (SRAM). The bus 1320 couples the processor 1308 to the memory 1312, also to the non-volatile storage 1316, and to the display controller 1314.

The display controller 1314 may control in the conventional manner a display on the display device 1306, which can be, for example, a cathode ray tube (CRT) or liquid crystal display (LCD). The display controller 1314 can be implemented with conventional well known technology.

The non-volatile storage 1316 is often a magnetic hard disk, flash memory, an optical disk, or another form of storage for large amounts of data. Some of this data is often written, by a direct memory access process, into memory 1312 during execution of software in the device 1302. One of skill in the art will immediately recognize that the terms “machine-readable medium” or “computer-readable medium” includes any type of storage device that is accessible by the processor 1308.

Clock 1322 can be any kind of oscillating circuit creating an electrical signal with a precise frequency. In a non-limiting example, clock 1322 could be a crystal oscillator using the mechanical resonance of vibrating crystal to generate the electrical signal.

The system 1300 is one example of many possible computer systems which have different architectures. For example, personal computers based on an Intel microprocessor often have multiple buses, one of which can be an I/O bus for the peripherals and one that directly connects the processor 1308 and the memory 1312 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1312 for execution by the processor 1308. A Web TV system, which is known in the art, is also considered to be a computer system, but it may lack some of the features shown in FIG. 13, such as certain input or output devices. A typical computer system will usually include at least a processor, memory, and a bus coupling the memory to the processor.

In addition, the system 1300 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 1316 and causes the processor 1308 to execute the various acts required by the operating system to input and output data and to store data in memory, including storing files on the non-volatile storage 1316.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs. EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A method for distance-based sharing of content, the method comprising:
receiving a request to send content to one or more of a plurality of registered users based on a distance from a first geographical location;
determining recipients of the content based on the distance and based on location identification data associated with the registered users;
making said content available to said recipients.

2. The method of claim 1, wherein the step of making the content available to the recipients includes publishing the content on a website accessible to the recipients.

3. The method of claim 1, wherein the step of making the content available to the recipients includes sending said content to the recipients.

4. The method of claim 3 further including sending said content to the recipients via email.

5. The method of claim 1, wherein the first geographical location is a location of a user requesting to send the content to the recipients.

6. The method of claim 1 further comprising presenting said content to the recipients on an interface.

7. The method of claim 6, wherein said interface is a website.

8. The method of claim 6 further comprising enabling the recipients to filter the content based on one or more of: geographic filter, people-based filter, interest-based filter, or any other filter.

9. A system for distance-based content sharing, the system comprising:
a database including location identification data associated with a plurality of registered users;
an interface module for publishing content distributed by a first registered user, the first registered user associated with a first geographic location;
wherein, in operation, the interface module publishes the content to one or more of the plurality of registered users based on a distance between the first geographic location and the location identification data.

10. A system for distance-based content sharing, the system comprising:
means for receiving a request to send content to one or more of a plurality of registered users based on a distance from a first geographic location;
means for determining recipients of the content based on the distance and based on location identification data associated with the registered users;
means for making said content available to said recipients.

11. A method for distance-based sharing of content, the method comprising:
providing a platform for users to register, wherein registered users are each associated with a geographic location;
identifying registered users having the geographic location within a user defined distance from a first geographic location;
sharing the content with the identified registered users.

12. The method of claim 11, wherein the content is shared through an interface.

13. The method of claim 12, wherein the interface is a web browser.

14. The method of claim 12, wherein the interlace is an application having access to a network.

15. The method of claim 11, wherein the content is created by a first registered user having a second geographic location different to the first geographic location.

16. The method of claim 11, wherein each of the registered users are associated with more than one geographic location.
